(19) United States
(12) Patent Application Publication
(10) Pub. No.: US 2003/0124988 A1
(43) Pub. Date: Jul. 3, 2003

(54) Reverse link control method in a mobile communication system

(75) Inventors: Beom-Sik Bae, Suwon-shi (KR); Dong-Seek Park, Suwon-shi (KR); Chang-Hoi Koo, Songnam-shi (KR); Dae-Gyun Kim, Taegukwangyok-shi (KR); Young-Wook Jung, Taejonkwangyok-shi (KR); Dong-Ho Cho, Seoul (KR); Jung-Woo Cho, Koje-shi (KR)

Correspondence Address: Paul J. Farrell, Esq., DILWORTH & BARRESE, LLP, 333 Earle Ovington Blvd., Uniondale, NY, 11553, US

(73) Assignee: SAMSUNG ELECTRONICS CO., LTD., Kyungki-do (KR)

(21) Appl. No.: 10/280,559

(22) Filed: Oct. 25, 2002

(30) Foreign Application Priority Data
Oct. 27, 2001 (KR) 66595/2001

(51) Int. Cl. H04B 7/216

(52) U.S. Cl. 455/88

(57) ABSTRACT

A reverse link control method in a mobile communication system. To increase or decrease a reverse data rate, an MS receives access probabilities for at least one-level rate increases and decreases from each available data rate from a serving BS and stores them. Upon receipt of a reverse data rate increase or decrease command from the BS, the MS reads access probabilities for a current data rate and generates a random number. Then it compares the random number with the read access probabilities and, if the random number satisfies the read access probabilities, it increases or decreases its current data rate by one or more levels according to the read access probabilities.

### PRIORITY

This application claims priority to an application entitled “Reverse Link Controlling Method in a Mobile Communication System” filed in the Korean Industrial Property Office on Oct. 27, 2001 and assigned Ser. No. 2001-66595, the contents of which are hereby incorporated by reference.

### BACKGROUND OF THE INVENTION

1. Field of the Invention

The present invention relates generally to a data rate controlling method in a mobile communication system, and in particular, to a reverse data rate controlling method.

2. Description of the Related Art

In general, IMT-2000 1xEV-DO (Evolution-Data Only) is a CDMA technique for providing high-speed data transmission only. Appropriate scheduling is required to efficiently transmit forward and reverse packet data in the 1xEV-DO system. Considering air states and other environmental factors between a base station (BS) and mobile stations (MSs), the BS transmits data only to an MS at the best channel condition, thereby maximizing transmission throughput. For reverse packet data transmission, however, a plurality of MSs access the BS simultaneously. Therefore, the BS must control overload within its capacity through appropriate control of reverse data flow and traffic congestion. 1xEV-DV (Evolution Data and Voice), a novel system under standardization, aiming at high-speed data transmission and voice service, is not an exception in this sense.

In the 1xEV-DO system, an MS carries out reverse data transmission according to a RAB (Reverse Activity Bit) and a ReverseRateLimit (RRL) message received from a BS, and tells the BS its variable data rate via an RRI (Reverse Rate Indicator). The RRI indicates to the BS the data rate at which the reverse traffic data is being sent. The BS transmits time-division-multiplexed channels to the MS on an F-MAC (Forward Medium Access Control) channel: a pilot channel, an RPC (Reverse Power Control) channel, and a RAB channel. The RAB represents the congestion degree of the reverse link and a data rate available to the MS varies according to the RAB. The BS controls a data flow from the MS by commanding an increase/decrease in the reverse data rate using the RAB to thereby control the overload and capacity of the reverse link. The transmission time (or transmission period) of the RAB is determined by

T mod RABlength (1)

where T is system time and RABlength is the length of the RAB expressed in a number of slots. Table 1 below lists binary values representing RAB lengths. The BS transmits one of the binary values to the MS in one slot and then the MS calculates a slot time when it receives the RAB on an F-MAC channel using the received RABlength information and the system time.

TABLE 1

| Binary | Length (slots) |
|---|---|
| 00 | 8 |
| 01 | 16 |
| 10 | 32 |
| 11 | 64 |

With the RAB received from the BS at the time calculated by Eq. (1), the MS determines a data rate available for the current reverse transmission. The MS receives persistence vectors in a message from the BS at or during a connection. The persistence vectors are used in a persistence test for increasing or decreasing a data rate when RAB=0 or RAB=1, respectively. If the persistence test is passed, the MS doubles the current data rate or reduces it by half. If the persistence test is failed, the MS maintains the current data rate. Specifically, when RAB=0 and the persistence test is passed, the MS doubles the data rate. When RAB=1 and the persistence test is passed, the MS reduces the data rate by half. Here, it is determined that the persistence test is passed if a random number satisfies a persistence vector.

From the system's perspective, this reverse data rate controlling method facilitates bandwidth and overload control. However, its uniform control for all MSs without considering their individual characteristics does not ensure efficient resource utilization.

The reverse data rate control method in the 1x EV-DO system will be described below. FIG. I is a flowchart illustrating the reverse data rate control method in an MS in the 1xEV-DO system.

The MS transmits initial data at a default data rate 9.6 Kbps on the reverse link in step 10 and monitors an F-MAC channel in step 12. Upon receipt of an RAB on the F-MAC channel in step 14, the MS searches for an access probability Pi for the current data rate and generates a random number R in step 16. In step 18, the MS determines whether the RAB is 1. If the RAB is 1, commanding a data rate decrease, the procedure advances to step 22 and if the RAB is 0,commanding a data rate increase, the procedure advances to step 20.

If the random number R is equal to or less than the access probability Pi, which implies that a persistence test is passed, in step 20 or step 22, the MS increases or decrease its data rate by one level in step 24 or step 26, respectively. The MS transmits data at the changed data rate in step 28. If the changed data rate is lower than a data rate set in an RRL message, the MS transmits data on the set data rate 32 slots (53.33 ms) later. On the other hand, if the changed data rate is higher than the set data rate, the MS immediately changes its data rate to the set data rate.

After determining its data rate, the MS tells the BS the data rate in an RRI symbol as listed in Table 2 below. The data rate is one of 0, 9.6, 19.2, 38.4, 76.8 and 153.6 Kbps.

TABLE 2

| Data rate (kbps) | RRI symbol |
|---|---|
| 0 | 000 |
| 9.6 | 001 |
| 19.2 | 010 |
| 38.4 | 011 |
| 76.8 | 100 |
| 153.6 | 101 |

To aid the MS in resetting its data rate, the BS transmits to the MS an RRL message having the structure shown in Table 3.

TABLE 3

| Field | Length (bits) |
|---|---|
| Message ID | 8 |

29 occurrences of the following two fields

| | |
|---|---|
| RateLimitIncluded | 1 |
| RateLimit | 0 or 4 |
| Reserved | Variable |

Upon receipt of the RRL message, the MS resets its data rate by comparing the current data rate with a data rate set in the RRL message. 29 records may be inserted in the above RRL message and each record indicates a data rate assigned to a corresponding one of MACindexes 3 to 31. In Table 3, Message ID indicates the ID of the RRL message. RateLimitIncluded is a field indicating whether RateLimit is included in the RRL message. If RateLimit is included, RateLimitIncluded is set to 1, and otherwise, it is set to 0. RateLimit indicates a data rate assigned to a corresponding MS. The BS assigns data rates listed below in Table 4 to MSs using four bits.

TABLE 4

| | |
|---|---|
| 0 × 0 | 0 Kbps |
| 0 × 1 | 9.6 Kbps |
| 0 × 2 | 19.2 Kbps |
| 0 × 3 | 38.4 Kbps |
| 0 × 4 | 76.8 Kbps |
| 0 × 0 | 153.6 Kbps |

All other values are invalid

During reverse data transmission, the MS monitors the F-MAC channel from the BS, especially the RAB on the F-MAC channel and resets its current data rate by performing a persistence test.

FIG. 2 is a diagram illustrating data transmission/reception between an MS and 1xEV-DO sectors in its active set using a sectored BS. Referring to FIG. 2, F-traffic and R-traffic channels and F-MAC and R-MAC channels have been established between the MS and sector 1 with a connection opened between them. No F-traffic channels are assigned to the MS from sector 2 (up to six sectors 2 to 6) with no connection opened between them. In the 1xEV-DO system, the MS can maintain up to six sectors/BSs in its active set. Therefore, the MS monitors F-MAC channels from the active set sectors, especially RABs to determine its data rate.

Upon receipt of at least one RAB set to 1, the MS performs a persistence test to decrease its data rate. In the persistence test, the MS generates a random number and compares it with a persistence vector for increasing a data rate as defined by the BS at or during a connection. If the random number satisfies the persistence vector, the MS reduces its data rate by half, considering that the persistence test is passed. On the contrary, if the persistence test is failed, the MS maintains its data rate. If the data rate is lower than the default data rate, the MS sets its data rate to the default data rate. Meanwhile, if all the RABs are 0 and a persistence test is passed, the data rate is doubled. If the persistence test is failed, the MS maintains its data rate. If the increased data rate is higher than the highest available data rate, the MS sets its data rate to the highest data rate. When the MS is limited in transmission power, it maintains its data rate. The RAB that leads to a one-time data rate increase or a half-data rate decrease on the reverse link is broadcast to MSs in time-division-multiplexing with an RPC on a forward common channel, the F-MAC channel. The MSs perform persistence tests to increase or decrease their data rates uniformly according to the RAB.

In this reverse data rate control method for the 1xEV-DO system, reverse data rate is controlled based on probability because a persistence test is performed according to a RAB. As a result, the full utilization of the reverse link is delayed. The uniform control that occurs without considering the individual statuses of MSs brings about resources waste. Yet, an individual data rate control drastically increases overhead, thereby deteriorating system performance.

### SUMMARY OF THE INVENTION

It is, therefore, an object of the present invention to provide an apparatus and method for assigning different data rate increments and decrements to MSs according to their characteristics to efficiently control reverse data transmission in a mobile communication system.

It is another object of the present invention to provide an apparatus and method for controlling reverse access by changing a reverse data rate according to an access probability assigned from a BS in an MS.

It is also another object of the present invention to provide an apparatus and method for increasing a reverse data rate by two or more levels in an MS.

It is a further object of the present invention to provide an apparatus and method for efficiently controlling an overload of a BS by allowing an MS to increase or decrease its data rate by two or more levels.

It is still another object of the present invention to provide an MS-based rate controlling apparatus and method for increasing and decreasing a data rate of an MS according to its characteristics.

It is yet another object of the present invention to provide an apparatus and method for controlling reverse data transmission considering QoS (Quality of Service), a position of an MS, channel condition, or a priority level of the MS to efficiently control an overload of a BS and thus ensure system performance and system capacity.

It is also yet another object of the present invention to provide an apparatus and method for controlling bandwidth efficiently on an MS basis and assigning bandwidth dynamically by an efficient control of an overload of a BS in a 1xEV-DO mobile communication system.

To achieve the above and other objects, to increase or decrease a reverse data rate, an MS receives access probabilities for one or more-level rate increases and decreases from each available data rate from a serving BS and stores them. Upon receipt of a reverse data rate increase or decrease command from the BS, the MS reads access probabilities for a current data rate and generates a random number. The MS then compares the random number with the read access probabilities and, if the random number satisfies the access probabilities, it increases or decreases its current data rate by one or more levels according to the access probabilities.

To control reverse data rates, a BS transmits access probabilities for at least one-level rate increases and decreases to MSs when the MSs initially enter the service area of the BS. The BS detects reverse rate indicators received from the MSs, sets an RAB based on a load of a reverse link, a remaining reverse link capacity, and access probabilities, and transmits the RAB to the MSs.

### BRIEF DESCRIPTION OF THE DRAWINGS

The above and other objects, features, and advantages of the present invention will become more apparent from the following detailed description when taken in conjunction with the accompanying drawings in which:

FIG. 1 is a flowchart illustrating a reverse data rate control method in an MS in a 1xEV-DO system;

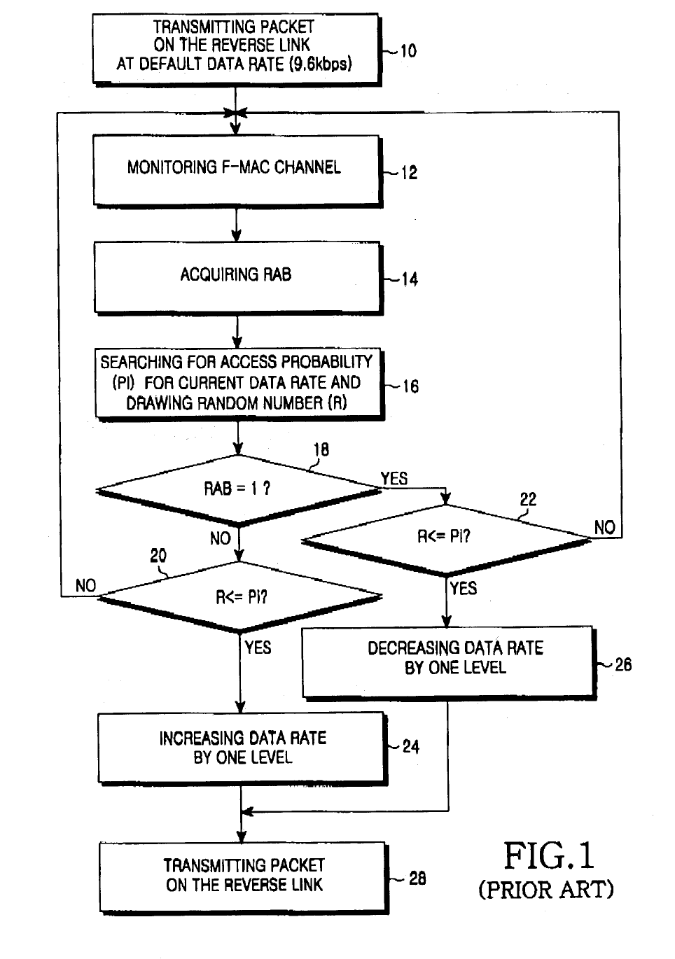

FIG. 2 is a diagram illustrating operations between an MS and 1xEV-DO sectors in its active set;

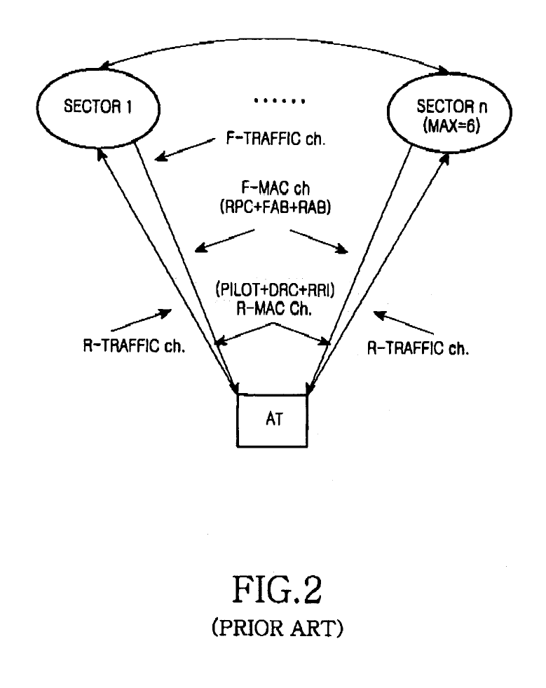

FIG. 3 is a flowchart illustrating an operation of a BS to perform a reverse data rate control method in a mobile communication system according to an embodiment of the present invention; and

FIG. 4 is a flowchart illustrating an operation of an MS to perform a reverse data rate controlling method in a mobile communication system according to the embodiment of the present invention

### DETAILED DESCRIPTION OF THE PREFERRED EMBODIMENT

A preferred embodiment of the present invention will be described herein below with reference to the accompanying drawings. In the following description, well-known functions or constructions are not described in detail since they would obscure the invention in unnecessary detail.

A reverse data rate control method according to the present invention is similar to a conventional reverse data rate controlling method using an RAB and PV (Persistence Vector) tests for 1xEV-DO in that the RAB is broadcast to all MSs and the MSs determine their data rates by performing PV tests. Yet, a feature of the present invention is that at least one-level data rate increase or decrease is available according to a result of a PV test using a plurality of PV values.

The following description is made in the context of 1xEV-DV, which is being discussed in the 3GPP2.

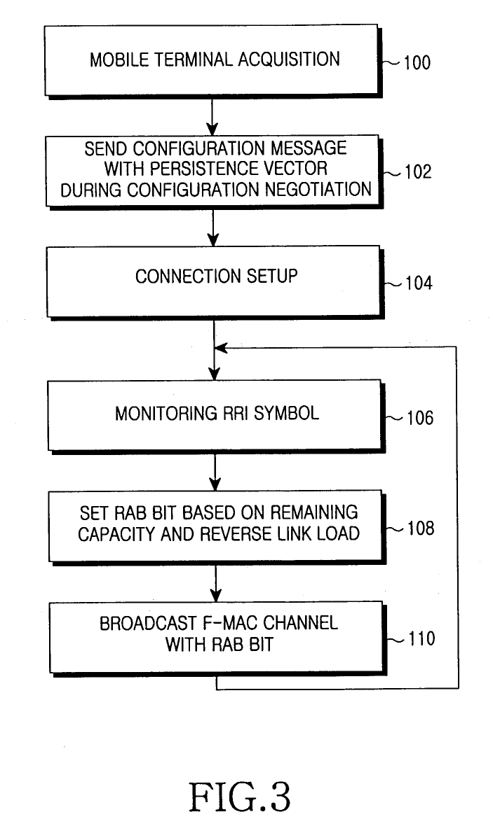

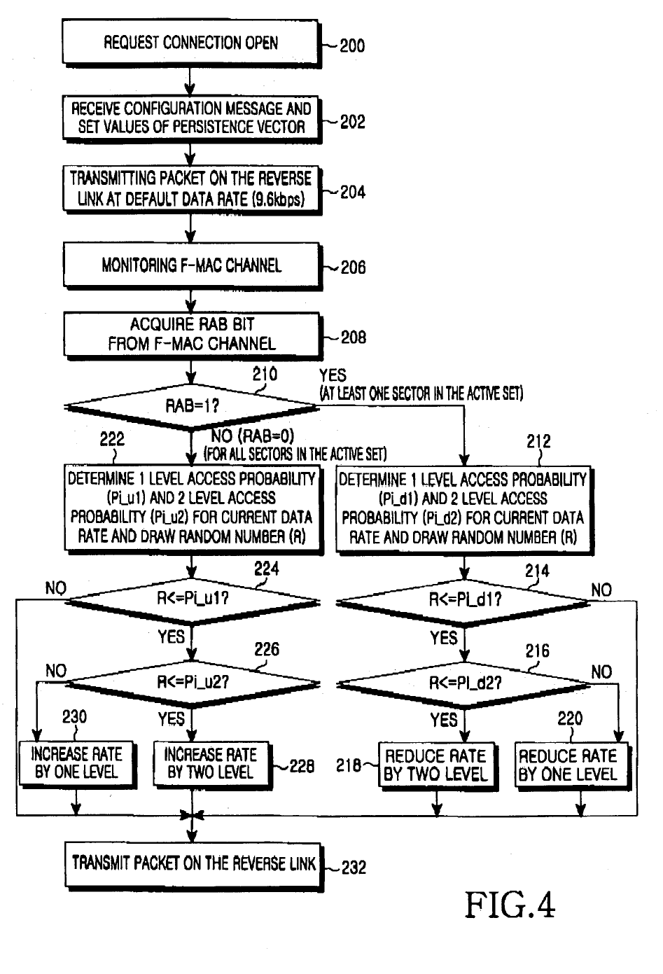

FIGS. 3 and 4 are flowcharts illustrating the operations of a BS and an MS to perform a reverse data rate control method in a system according to an embodiment of the present invention. In the procedures illustrated in FIGS. 3 and 4, an up to two-level data rate increase or decrease is available. However, it should be noted that the present invention is applicable to a procedure for increasing and decreasing more than a two-level data rate.

Prior to a reverse data rate control according to the present invention, each MS receives PV values from a BS by a configurable attribute in a configuration message for use in configuration negotiations at a call set-up. The PV values can be changed. Then the PV values are transmitted to the MSs by puncturing an existing message or a novel signaling message. It is assumed here that the PV values are transmitted to the MSs by a configuration message. Table 5 below is an example of a message attribute for delivering PV values.

TABLE 5

| Field | Length (bits) |
|---|---|
| Length | 8 |
| AttributeID | 8 |

One or more of the following record

| | |
|---|---|
| ValueID | 4 |
| Transition009k6_019k2 | 4 |
| Transition009k6_038k4 | 4 |
| Transition019k2_038k4 | 4 |
| Transition019k2_076k8 | 4 |
| Transition038k4_076k8 | 4 |
| Transition038k4_153k6 | 4 |
| Transition076k8_153k6 | 4 |
| Transition019k2_009k6 | 4 |
| Transition038k4_019k2 | 4 |
| Transition038k4_009k6 | 4 |
| Transition076k8_038k4 | 4 |
| Transition076k8_019k2 | 4 |
| Transition153k6_076k8 | 4 |
| Transition153k6_038k4 | 4 |

The message attribute includes two kinds of PV values. In Table 5, Transition009k6_{—}019k2 is a probability of passing a PV test for a one-level data rate increase from 9.6 kbps to 19.2 kbps, and Transition009k6_{—}038k4 is a probability of passing a PV test for a two-level data rate increase from 9.6 kbps to 38.4 kbps. For example, if the current data rate of an MS is 9.6 kbps and an RAB is 0, a PV value for a primary PV test is the value of Transition009k6_{—}019k2, and a PV value for a secondary PV test is the value of Transition009k6_{—}038k4.

In the same manner, Transition038k4_{—}019k2 is a probability of passing a PV test for a one-level data rate decrease from 38.4 kbps to 19.2 kbps and Transition038k4_{—}009k6 is a probability of passing a PV test for a two-level data rate decrease from 38.4 kbps to 9.6 kbps. The above message format is a mere exemplary application, but modifications can be made to specific values only.

TABLE 6
lists values of the fields versus access probabilities.

| Value | Probability |
|---|---|
| 0 × 0 | 0.0000 |
| 0 × 1 | 0.0625 |
| 0 × 2 | 0.1250 |
| 0 × 3 | 0.1875 |
| 0 × 4 | 0.2500 |
| 0 × 5 | 0.3125 |
| 0 × 6 | 0.3750 |
| 0 × 7 | 0.4375 |
| 0 × 8 | 0.5000 |
| 0 × 9 | 0.6250 |
| 0 × A | 0.6875 |
| 0 × B | 0.7500 |
| 0 × C | 0.8125 |
| 0 × D | 0.8750 |
| 0 × E | 0.9375 |
| 0 × F | 1.0000 |

Referring to Table 6, if Transition009k6_{—}019k2 is 0×6, it means that an access probability of increasing 9.6 kbps to 19.2 kbps is 0.3750. Table 6 is also exemplary and thus modifications can be made to it.

Referring to FIG. 3, MSs transmit connection open request messages to a BS. Then the BS acquires the MSs in step 100 and conducts configuration negotiations with the MSs, for connection setup in step 102. At the configuration negotiations, the BS transmits PV values to the MSs by a configuration message as illustrated in Table 5 and Table 6. Upon completion of the connection setup in step 104, the BS exchanges packet data with the MSs and the MSs tell the BS their data rates by RRI symbols. The BS monitors the RRI messages and checks its system capacity and the reverse link load state in step 106 and sets an RAB taking into account the RRI messages, the BS capacity, and the PV values transmitted to the MSs in step 108.

In step 110, the BS broadcasts the RAB on an F-MAC channel. Returning to step 106, the BS detects RRI symbols from the MSs a predetermined time later. In this manner, the BS controls the data rates of the MSs.

Referring to FIG. 4, an MS transmits a connection open request message to a BS in step 200. The BS transmits a configuration message containing a message illustrated in Table 5 and Table 6 in response to the connection open request message to set up a connection with the MS. In step 202, the MS detects PV values from the configuration message and stores them in a memory. When the connection is established, the MS attempts an initial reverse access at 9.6 kbps in step 204. While 9.6 kbps is a default data rate in 1xEV-DO, the default data rate is system-dependent.

The MS monitors F-MAC channels, especially RABs during the reverse data transmission in step 206. The MS receives as many RABs as the number of active set sectors/BSs. A serving sector/BS assigns F-traffic and F-MAC channels and R-traffic and R-MAC channels to the MS when a connection is opened between them. When a connection is not opened between the MS and a sector/BS, the MS monitors only a control channel including an F-MAC channel from the sector/BS.

In step 208, the MS acquires the RABs, stores them, and generates a random number R to be compared with PV values Pi_d1 Pi_d2, Pi_u1, and Pi_u2 received from the BS. Then the MS determines whether at least one RAB is 1 in step 210. If at least one RAB is 1, the MS goes to step 212 and if all the RABs are 0, the MS goes to step 222.

In step 212, the MS reads an access probability Pi_d1 for a one-level decrease and an access probability Pi_d2 for a two-level decrease and generates the random number R. The MS performs a primary PV test by comparing the access probability Pi_d1 with the random number R in step 214. If the random number R is greater than the access probability Pi_d1, the MS maintains its current data rate and returns to step 206 to monitor the F-MAC channels. On the other hand, if the random number R is equal to or less than the access probability Pi_d1, the MS performs a secondary PV test by comparing the random number with the access probability Pi_d2 in step 216. If the random number R is greater than the access probability Pi_d2, the MS decreases its current data rate by one level in step 220 and transmits data at the decreased data rate in step 232. If the current data rate is lowest, the MS maintains the current data rate. On the other hand, if the random number R is equal to or less than the access probability Pi_d2, the MS decreases the current data rate by two levels in step 218 and transmits data at the decreased data rate in step 232. If the current data rate is lowest, the MS maintains the current data rate, and if only one-level rate decrease is available, the MS decreases the data rate by one level.

Meanwhile, if all the RABs are 0 in step 210, the MS reads an access probability Pi_u1 for a one-level increase and an access probability Pi_u2 for a two-level increase and generates the random number R in step 222. While all RABs are 0, MSs increase their data rates by one level or maintain them according to their transmission power and the highest available data rate in the existing 1xEV-DO systems. A two or more-level rate increase is available by performing PV tests using two PV values in the present invention.

The MS performs a primary PV test by comparing the access probability Pi_u1 with the random number R in step 224. If the random number R is greater than the access probability Pi_u1, the MS maintains its current data rate and returns to step 206 to monitor the F-MAC channels. On the other hand, if the random number R is equal to or less than the access probability Pi_u1, the MS performs a secondary PV test by comparing the random number R with the access probability Pi_u2 in step 226. If the random number R is greater than the access probability Pi_u1, the MS increases its current data rate by one level in step 230 and transmits data at the increased data rate in step 232. If the current data rate is highest, the MS maintains the current data rate. On the other hand, if the random number R is equal to or less than the access probability Pi_u2, the MS increases the current data rate by two levels in step 228 and transmits data at the increased data rate in step 232.

If the current data rate is highest, the MS maintains the current data rate, and if only a one-level rate increase is available, the MS increases the data rate by one level. The specific rate increments and decrements can be changed and the PV values can be received from the BS at a call setup or during a call.

Although many modifications can be made to the above-described embodiment of the present invention, they are realized in the same manner except that different parameters are set.

In accordance with the present invention as described above, reverse data rates can be controlled individually or grouped. With a resulting efficient control of an overload of a BS, system performance and capacity are ensured. Furthermore, a reverse data rate control based on characteristics of individual MSs results in efficient bandwidth control and dynamic bandwidth assignment.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A method of increasing and decreasing a reverse data rate in a mobile station (MS) in a mobile communication system where a predetermined number of reverse data rates are available to each of a plurality of MSs within a service area of a base station (BS), the method comprising the steps of:
receiving access probabilities for at least one-level rate increases and decreases from each available data rate from the BS and storing the access probabilities;
reading access probabilities for a current data rate upon receipt of a reverse data rate increase or decrease command from the BS, and generating a random number; and
comparing the random number with the read access probabilities, and, if the random number satisfies the read access probabilities, increasing or decreasing the current data rate by at least one level according to the read access probabilities.

2. The method of claim 1, wherein the reverse data rate increase command is valid when the MS receives rate increase commands from all BSs in an active set of the MS.

3. The method of claim 1, wherein the reverse data rate decrease command is valid when the MS receives a rate decrease command from at least one BS in an active set of the MS.

4. The method of claim 1, further comprising the steps of:
reading an access probability for each level rate increase from the current data rate upon receipt of the reverse data rate increase command, and generating the random number; and
increasing the current data rate to a highest available data rate if the random number satisfies at least two access probabilities.

5. The method of claim 4, further comprising the step of increasing the current data rate to a highest available data rate if the increased data rate exceeds the highest available data rate.

6. The method of claim 1, further comprising the steps of:
reading an access probability for each level rate decrease from the current data rate upon receipt of the reverse data rate decrease command, and generating the random number; and
decreasing the current data rate to a lowest available data rate if the random number satisfies at least two access probabilities.

7. The method of claim 6, further comprising the step of decreasing the current data rate to a lowest available data rate if the decreased data rate is lower than lowest available data rate.

8. A reverse data rate controlling method in a base station (BS) in a mobile communication system where a predetermined number of reverse data rates are available to each of a plurality of mobile stations (MSs) within a service area of the BS, the method comprising the steps of:
transmitting access probabilities for at least one-level rate increases and decreases to MSs when the MSs initially enter the service area of the BS;
detecting reverse rate indicators (RRIs) received from the MSs;
setting a reverse activity bit (RAB) based on a load of a reverse link, a remaining reverse link capacity, and the transmitted access probabilities; and
transmitting the RAB to the MSs.

9. The method of claim 8, wherein the RAB is broadcast to the MSs.
